(19) United States
(12) Patent Application Publication
(10) Pub. No.: US 2022/0315840 A1
(43) Pub. Date: Oct. 6, 2022

(54) Flame Retardant, Method for Its Manufacture and Article Comprising Such Flame Retardant

(71) Applicant: Klingelberg Products AS, Oppegaard (NO)

(72) Inventor: Ferdinand Männle, Oppegaard (NO)

(21) Appl. No.: 17/633,616

(22) PCT Filed: Aug. 6, 2020
(86) PCT No.: PCT/NO2020/050201

§ 371 Date: Feb. 8, 2022

(30) Foreign Application Priority Data
Aug. 9, 2019 (NO) 20190970

(51) Int. Cl. C09K 21/08; C09D 5/18; C09K 21/02; C09D 133/06

(52) U.S. Cl. CPC C09K 21/08; C09D 5/18; C09K 21/02; C09D 133/06; C08K 2003/2272

(57) ABSTRACT

Method for the preparation of a flame retardant, comprising iron and chlorine in the chemical compositions of its components, comprising at least: —providing an iron containing chemical substance —providing a chlorine containing chemical substance, and bringing said iron containing chemical substance and said chlorine containing chemical substance in contact with each other, to thereby form an at least partially volatile ferric chloride acting as a flame poison. The flame retardant thus formed is also contemplated as well as articles to which the flame retardant is applied.

### BACKGROUND

The disclosed embodiments relate to flame retardants, and more particularly flame retardant and flame retardant mixtures comprising flame poisons. More particularly, the disclosed embodiments relate to a flame poison suitable as flame retardant, wherein the flame poison exhibits good coating capability of substrate materials and good miscibility with coating or moulding compositions. Flame retardancy is provided at a low weight-to-weight ratio in relation to substrate or matrix.

Flame retardants inhibit, suppress, or delay ignition of flammable materials and prevent the spread of fire. They interfere with radical processes, which are important for the development of fire, act as chemical coolants and/or form a barrier between the fire and the flammable material.

Flame retardants comprising flame poisons are widely investigated. Char yield can be improved when flame poisons effectively interfere in the thermal oxidation of materials in the initial state of fire development. In order to be efficient, flame poisons need to have a certain volatility. Volatility enables flame poisons to interact with combustible degradation products which are formed under flame conditions and during the development of fire.

Halogenated flame retardants and especially brominated flame retardants may act as flame poisons. An overview is given in “Hans Zweifel ed., Plastic Additives Handbook, 5th edition, Hanser Publishers Munich, pp. 681-689). US2019202972A teaches polyurethane foams containing a brominated flame retardant. US2019185669A discloses a flame retarded polyamide composition comprising a hydroquinone bisdiphenyl phosphate ester and at least one brominated flame retardant. US2018135239A teaches a flame retardant compositions suitable for textile coating, comprising a brominated flame retardant, an organic phosphate and a flame retardant which is a source of nitrogen and inorganic phosphorus. EP 3063216 B1 discloses foamed styrenic polymers containing a brominated styrene-butadiene copolymer and having enhanced cell size homogeneity. CN 108659445 A and CN 109180881 A teach the manufacturing of styrene based polymer materials comprising brominated flame retardants.

Antimony oxide is often used as synergist together with brominated flame retardants. US 2014371366 A discloses a flame retardant polyester composition comprising a polyester, a brominated flame retardant compound, an antimony flame retardant compound, and an alkali metal carbonate. US 2015302952 A discloses a cable with insulated conductors, which are surrounded by a dielectric material that includes polyolefin, a brominated flame retardant, and antimony trioxide.

The antimony oxide synergist and the brominated compound provide together flame retardancy by formation of antimony bromide (SbBr₃). SbBr₃ has a boiling point of 280° C. at atmospheric pressure and is therefore volatile enough to interfere with the thermal oxidation of volatile combustible degradation products under flame conditions. SbCl₃ which can be formed from antimony oxide synergist and a chlorinated compound, has a boiling point of 220° C. at atmospheric pressure and works in a similar way.

The major drawback of antimony is its status as heavy metal, which provides limited acceptance in industry from an environmental point of view. The same is true for brominated or chlorinated substances which are persistent in the environment and/or can bio-accumulate. Some of these brominated or chlorinated substances are investigated with respect to endocrine and thyroid disruption, impacts to the immune system, reproductive toxicity, cancer, adverse effects on fetal and child development and neurologic function.

Flame poison effects can be provided by chemical substances which break down endothermally and emit water when subjected to temperatures above 200° C. or 300° C. Magnesium and aluminium hydroxides are examples, together with various carbonates and hydrates such as mixtures of huntite and hydromagnesite. The endothermal reaction removes heat from the substrate, thereby cooling the material. Water, which is formed, serves as effective radical scavenger and flame poison. WO 15092209 A1 relates to a halogen-free, fireproof, thermoplastic composition consisting of: 50-75 wt-% w/w of fireproofing fillers in ethylene based polymers and copolymers. The fireproofing fillers are selected among aluminium hydroxide, hydromagnesite, dawsonite, magnesium hydroxide, magnesium carbonate subhydrate, boehmite, calcium hydroxide or huntite. TW 20101287 A discloses is a flame-retardant polyurethane resin that is free of halogen comprising an inorganic flame retardant selected from the group of metal hydroxides or metal oxides. KR 20090097284 A discloses a composition for a flame retardant expansion member, comprising 11-70 wt-% of a non-crosslinking polymer, 20-80 wt-% of an inorganic flame retardant, 5-30 wt-% of a blowing agent, and 0.2-10 wt-% of a lubricant. The inorganic flame retardant is selected from the group consisting of aluminium hydroxide, magnesium hydroxide, potassium hydroxide, basic magnesium carbonate, hydrotalcite, huntite, and hydromagnesite. High loadings of inorganic flame retardant have to be used in order to obtain an acceptable flame retardant effect.

CN 104893567 A, CN 103524840 A, CN 102977585 B and RU 2495894 C disclose flame retarded polymer compositions comprising chlorine containing substances and iron oxide. However significant amounts of known and highly effective flame retardants such ammonium polyphosphate, zinc borate and/or combinations of antimony trioxide and brominated flame retardants are mandatory in these polymer compositions.

U.S. Pat. No. 4,024,093 discloses flame retarded polymer compositions comprising organic iron salts and chlorinated and/or brominated flame retardants together with polymer blends consisting of 35 wt-% of polyphenylene ether resin and 65 of polystyrene containing about 9 wt-% polybutadiene. Polyphenylene ether resin, which is a resin of low flammability, is mandatory in the compositions. High loads of chlorinated and/or brominated flame retardants (14-37 phr; “per hundred resin”) and very low loads of iron stearate (0.5 phr) are used in the examples. Levels of up to 37 phr of chlorinated chemical substance in a fire retarded polymer resin are nowadays not acceptable from an environmental point of view. A flame retardant effect on wood, cardboard or other cellulose based material is not shown.

There is a need to provide an environmentally acceptable flame poison that works as flame retardant for combustible materials at low loadings.

### SUMMARY

Provided herein is a flame retardant that works as flame poison and which gives flame retardancy to combustible materials at low loadings. Also provided are methods for the manufacture of flame retardant. It is a still further objective to improve the fire resistance of flammable materials by processes such as, but not limited to, coating or mixing with flame retardant.

Where not otherwise stated, all percentages of components and substances mentioned in this document are by weight.

Iron(III) chloride (ferric chloride, FeCl₃) as flame poison is much more acceptable from an environmental point of view than SbCl₃ or SbBr₃. The boiling point of FeCl₃ is 315° C. at atmospheric pressure and not far away from the boiling point of SbBr₃ (280° C.), which as described above, works as an excellent flame poison. However, FeCl₃ is at least as corrosive as the antimony halides. A direct use in flame retardant composition would therefore be a challenge. Formation of FeCl₃ from ferric oxide and chlorinated compounds is slow due to the stability of the Fe—O—Fe bond. Surprisingly it has been found that freshly prepared iron hydroxides, organic iron salts or mixed iron hydroxides/organic salts, which are mixed with reactive chlorine compounds can form FeCl₃ upon heating. The reaction is fast enough to form enough flame poison FeCl₃ in order to provide flame retardancy to combustible materials. A reactive organic chlorine compound may comprise at least one covalent C—CI bond with a dissociation energy that is lower than the dissociation energy of the covalent C—CI bond in chloromethane. The type of carbon in the C—CI bond can be selected from the group of benzyl carbon, secondary carbon, tertiary carbon or allyl carbon. A reactive organic chlorine compound may become more reactive due to ongoing degradation under flame conditions. An example is the thermal degradation of polyvinylchloride which yields more and more reactive C—CI bonds during degradation and formation of hydrogen chloride. A typical reaction between iron(III) hydroxide and an organic chlorine compound can be expressed by reaction equation (I):

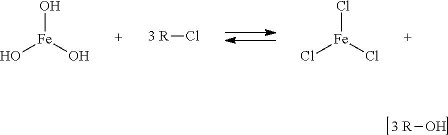

The by-product R—OH is presented in brackets, since a degradation under flame conditions is likely.

A method for the preparation of a flame retardant according to the present innovation comprises at least the following steps:
providing an iron containing chemical substance,
providing a chlorine containing chemical substance, and
mixing said iron containing chemical substance and said chlorine containing chemical substance,
thereby obtaining a mixture which is able to react under formation of an at least partially volatile ferric chloride upon subsequent heating.
   wherein said iron containing chemical substance in contact with said chlorine containing chemical substance upon heating and with flames present (flame conditions) act as flame poison by formation of at least partially volatile ferric chloride FeCl₃. Heating should be performed to at least 150° C., more preferred to at least 200° C. and even more preferred to at least 250° C. The closer the heating temperature is to the boiling point of the formed FeCl₃, the higher is its concentration in the gas phase, which is close to the surface of the combustible material. Such a presence is important for the effect of FeCl₃ as flame retardant and flame poison. Flame conditions and temperatures close to the boiling point of the formed FeCl₃ also lead to evaporation of FeCl₃ and to a shift of the equilibrium in reaction equation (I) to the right side. While bromine containing chemical substances are capable of forming volatile radicals upon heating and are able work as flame retardants, bromine containing chemical substances are not part of the present invention. That does not mean that presence of such substances would ruin the effect of the inventive embodiments, but their presence is neither mandatory nor preferred within the framework.

The yield of chemical reactions with two or more starting materials is frequently improved when the homogeneity of the mixture of starting materials is improved. The contact between chemical moieties and atoms which have to form the desired product is facilitated in a homogenous mixture. Starting materials consisting of large particles which give mixtures of average domain sizes of several microns in size may provide a slower reaction even at high temperature than a mixture which is prepared by mixing and drying solutions of the same starting materials. The average domain size of the mixtures should preferably not exceed 500 nm. Even more preferred are average domain sizes of the mixtures of less than 100 nm and most preferred are average domain sizes of the mixtures of less than 20 nm.

Use of iron containing chemical substances and/or chlorine containing chemical substances which are corrosive and/or form, in contact with water, substances of considerable acidity is a challenge. It is therefore an advantage that the pH value of a 5 wt-% w/w solution or dispersion of the iron containing chemical substance and/or of the chlorine containing chemical substance in water is higher than 4.

Suitable iron containing chemical substances can be selected from the group consisting of ferric hydroxide, ferric carboxylate, ferric salts of substituted carboxylates, ferric complexes of substituted carboxylates, ferric hydroxide carboxylate, ferric phosphate ester, ferric citrate, ferric gluconate, ferric silicate, ferric complexes with ligands comprising nitrogen and ferric substances comprising at least one covalent bond of the type Fe—O—Si, Fe—O—Al, Fe—O—Ti or Fe—O—P. Some examples are:

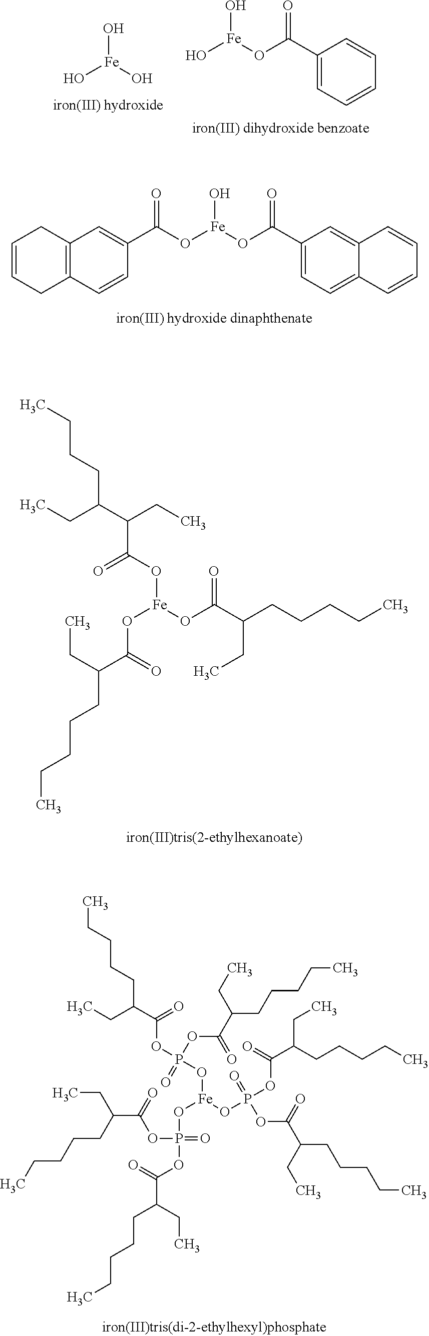

It is a general advantage if the iron containing chemical substance contributes to char formation under flame conditions. Char formation is facilitated by a high carbon content of the flame retardant. The atomic ratio of C:H in the iron containing chemical substance may therefore be larger than 0.50, preferably larger than 0.67, more preferred larger than 0.83 and most preferred larger than 1.0. Similar atomic ratio of C:H are preferred for the chlorine containing chemical substance.

Iron containing chemical substances in which iron has a different oxidation state than (III) can be suitable, since they can obtain oxidation state (III) in contact with air, in contact with the combustible substance or under flame conditions.

Halogenated substances, which are not volatile when applied onto or mixed into matter which flame retardancy are preferred. However decomposition and/or evaporation of such halogenated substances under flame conditions may occur.

Chlorinated substances are often perceived to have a negative environmental profile, in the same way as brominated substances. Polychlorinated dibenzodioxins like 2,3,7,8-tetrachlorodibenzodioxin, which is known as contaminant in a herbicide used in the Vietnam War and which was released into the environment in the Seveso disaster, contributed to the limited acceptance of chlorinated chemical substances by the public and the authorities. The same is true for pentachlorophenol, which has been used as a pesticide and a disinfectant. However, chlorinated chemical substances are naturally produced to a large extent. Bacteria, fungi and algae release annually about 5 million tons of chloromethane into the air. Annual release of chloromethane from industrial sources is about 30.000 tons (Laturnus F (2001). “Marine Macroalgae in Polar Regions as Natural Sources for Volatile Organohalogens”. Environ Sci Pollut Res. 8 (2): 103-108; http://www.welt.de/print-well/articles662145/Die-Natur-erfand-die-Chlorchemie.html). Peas use 4-chloroindole-3-acetic acid as grow hormone, because it is more effective than its non-chlorinated analogues (Reinecke, Dennis M. (1999). “4-Chloroindole-3-acetic acid and plant growth”. Plant Growth Regulation. 27 (1): 3-13). Many active pharmaceutical substances contain chlorine because they show higher effectiveness than similar unchlorinated substances. The antibiotic chloramphenicol is a well known example. Chlorinated substances may be used in industrial applications, provided that they are not harmful, toxic, mutagenic, carcinogenic or persistent in the environment.

Suitable chlorine containing substances for use within the disclosed embodiments are chlorinated sugars. An example is Sucralose (1,6-Dichloro-1,6-dideoxy-β-D-fructofuranosyl-4-chloro-4-deoxy-α-D-galactopyranosid) which is widely used as sweetener and which is 600 times sweeter than saccharose. Chlorinated waste products or chlorinated intermediates from sugar or sweetener production are also chlorine containing substances.

Heating of a mixture of an iron containing substance such as Fe(OH)₃ with chlorinated sugar such as sucralose can lead to the formation of char in addition to ferric chloride upon moderate heating, typically to 150° C. The formation of FeCl₃ facilitates the formation of char:

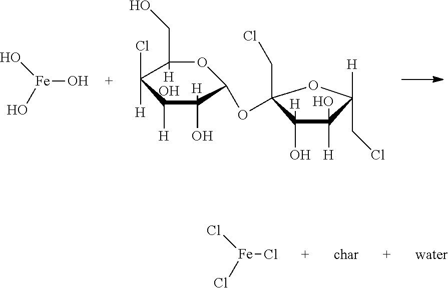

The formation of hydrogen chloride (HCl) and carbon (C, char) from parts of sucralose is facilitated by the presence of Fe(OH)₃ which forms FeCl₃ together with HCl.

In absence of Fe(OH)₃ sucralose is considerably more heat stable and can be used as sweetener in baking up to 250° C. without significant decomposition.

Other suitable chlorine containing chemical substances comprise nitrogen in their chemical composition and are at least partial hydrochlorides or quaternary salts with a molar ratio of chloride to nitrogen of 1:1000 to 1:1. The substance comprising nitrogen may be selected from the group consisting of amines, amine oxides, amidines, guanidines, imines and aromatic heterocycles.

The chlorine containing chemical substances can be a monomer, oligomer or polymer. Polymers or oligomers and monomers, which can form these, may be preferred since they in addition to serve as chlorine source can contribute to char formation.

The flame retardant may be mixed with hydrophobic matter selected from a group comprising binders, thermoplastics, thermosets, waxes, oils, fats and solvents. The flame retardant may be mixed with a flame retardant polymer in order to improve flame retardancy and/or reduce smoke release under flame conditions.

Environmental friendliness of flame retardants is not exactly defined. However there are binding regulations which can be used to assess or compare the environmental friendliness of chemical products. One of these regulations is the EU regulation on food contact materials (FCM) comprising polymer materials which are used in contact with food. Regulation (EU) No 10/2011 on plastic materials and articles intended to come into contact with food strictly limits the starting materials and components which can be used in food contact polymer materials. Most flame retardants are not allowed as FCM. Flame retardants or component in flame retardant mixtures which are FMCs according to regulation (EU) No 10/2011 are therefore perceived as environmentally friendly compared with flame retardants which are not FCMs and which are forbidden or strictly regulated in food contact applications.

The iron containing chemical substance and the chlorine containing chemical substance may be identical. An example is a iron(III) carboxylate with one or more partially chlorinated carboxylates.

The flame retardant or component in flame retardant mixtures may have the form of an aqueous or water-dilutable solution or dispersion.

A flame retardant may be present on different surfaces such as paper surfaces, cardboard surfaces, wooden surfaces or within wooden plates, boards, laminates, particle boards.

The flame retardancy of different articles or products can be improved if they comprise a flame retardant according to the disclosed embodiments. In addition to the flame retardant such articles or products can comprise binders, thermoplastics, thermosets, waxes, oils, fats, solvents, wooden plates, boards, laminates, particle boards or combinations thereof.

### EXAMPLE 1

### Iron(III) dihydroxide benzoate

1 mole (162 g) of Iron(III) chloride [7705-08-0] was dissolved in 500 g of water under stirring (150-200 min⁻¹). 3 moles (120 g) of sodium hydroxide [1310-73-2] were dissolved in 500 g of water and added to the solution of Iron(III) chloride under stirring within 5-10 minutes. A brownish cloudy dispersion was formed. A solution of 1 mole (144 g) of sodium benzoate [532-32-1] in 500 g of hot water (70-80° C.) was prepared and added to the brownish cloudy dispersion within 5 minutes under stirring. The mixture was allowed to cool down and kept at about 20° C. for 20 hours. A brown precipitation was formed under a clear and colourless water phase. The precipitation with the average composition Iron(III) dihydroxide benzoate was filtrated and a pasty product was obtained. Loss on dry at 120° C./30 min (LOD@120° C./30 min) was 78 wt-%. No further washing and/or drying was applied. The pasty Iron(III) dihydroxide benzoate (920 g) was mixed with 920 g of ethanol in order to obtain a pourable Iron(III) dihydroxide benzoate with LOD@120° C./30 min 89 wt-%. Iron content (calculated from LOD): 2.9 wt-%. The product comprises a Fe—O—C bond.

### EXAMPLE 2

### Iron(III) tris(2-ethylhexanoate)

1 mole (162 g) of Iron(III) chloride [7705-08-0] was dissolved in 500 g of water under stirring (150-200 min⁻¹). 3 moles (120 g) of Sodium hydroxide [1310-73-2] were dissolved in 500 g of water and added to the solution of Iron(III) chloride under stirring within 5-10 minutes. A brownish cloudy dispersion was formed. 3 moles (533 g) of neat 2-ethylhexanoic acid [149-57-5] were added under vigorous stirring (400-500 min⁻¹) within 20 minutes. Stirring was stopped and a phase separation of dark red Iron(III) 2-ethylhexanoate on top of a clear water phase was formed. The oily Iron(III) 2-ethylhexanoate was separated (533 g) and used without further washing and/or drying. Iron content (calculated from chemical composition): 10.1 wt-%. The product comprises a Fe—O—C bond.

### EXAMPLE 3

### Iron(III) tris(di-2-ethylhexylphosphate)

0.2 mole (32 g) of Iron(III) chloride [7705-08-0] was dissolved in 100 g of water under stirring (150-200 min⁻¹). 0.6 moles (120 g) of sodium hydroxide [1310-73-2] were dissolved in 100 g of water and added to the solution of Iron(III) chloride under stirring within 5-10 minutes. A brownish cloudy dispersion was formed, to which 0.6 mole (227 g) of neat Di-2-ethylhexylphosphoric acid were added under vigorous stirring (400-500 min⁻¹) within 20 minutes. A viscous to pasty, greyish mass separates from the water phase. The product was isolated and dried on filter paper for 2 hours at 20° C., which yields 248 g of a greyish, viscous pasty product. Loss on dry at 120° C./30 min (LOD@120° C./30 min) was 10 wt-%. The Iron(III) tris(di-2-ethylhexylphosphate) was mixed with 250 g of ethanol under heating to 60-70° C. in order to obtain a pourable dispersion with LOD@120° C./30 min of 48 wt-%. Iron content (calculated from LOD): 2.2 wt-%. The product comprises a Fe—O—P bond.

### EXAMPLE 4

### Iron(III) trihydroxide

0.5 mole (81 g) of Iron(III) chloride [7705-08-0] was dissolved in 250 g of water under stirring (150-200 min⁻¹). 2 moles (80 g) of sodium hydroxide [1310-73-2] were dissolved in 250 g of water and added to the solution of Iron(III) chloride under stirring within 5-10 minutes. A brownish cloudy dispersion was formed, which was poured into 500 g of water. The Iron(III) hydroxide product settles within 20 hours under a yellowish water phase. The precipitated product was separated and dried on filter paper for 2 hours at 20° C., which yields 234 g of a brown, pasty product. Loss on dry at 120° C./30 min (LOD@120° C./30 min) was 82 wt-%. The pasty Iron(III) trihydroxide was mixed with 120 g of ethanol in order to obtain a pourable Iron(III) trihydroxide with LOD@120° C./30 min of 88 wt-%. Iron content (calculated from LOD): 6.2 wt-%.

### EXAMPLE 5

### Sucralose (1,6-Dichloro-1,6-dideoxy-β-D-fructofuranosyl-4-chloro-4-deoxy-α-D-galactopyranosid)

0.05 moles (20 g) of sucralose (1,6-Dichloro-1,6-dideoxy-β-D-fructofuranosyl-4-chloro-4-deoxy-α-D-galactopyranosid, [56038-13-2] were dissolved in 10 g of water and 30 g ethanol under warming in order to obtain a 33 wt-% solution. Chlorine content (calculated): 8.9 wt-%

### EXAMPLE 6

0.4 mole (38 g) guanidine hydrochloride [50-01-1] were dissolved in a mixture of 10 g of water and 52 g of ethanol in order to obtain a 20 wt-% solution. Chlorine content (calculated): 7.4 wt-%

### EXAMPLE 7

### Flame Retardant Comprising a Molar Ratio of Fe and Cl of 1:3 in Addition to a Nitrogen and Silicon Containing Polymer

1 mole of 3-aminopropyltriethoxysilane [919-30-2] was introduced in a 1000 ml 3-necked reaction flask equipped with a reflux condenser and heated to 90-100° C. under stirring (150-200 min⁻¹). 0.5 mole of 4-hydroxymethylbenzoate [99-76-3] was added as powder within 5-10 minutes. 14 g of nanosilica dispersion (Levasil CS30-824P, Obermeier GmbH, Berleburg, Germany; LOD@120° C./30 min: 68 wt-%) was slowly added under vigorous stirring (400-500 min⁻¹) within 45 minutes. Reflux of formed ethanol occurs and the reaction mixture gets slightly hazy. After the addition of the nano silica dispersion was finished, the reaction mixtures was stirred vigorously (400-500 min⁻¹) under reflux for another 15 minutes. Thereafter reflux was switched to distillation and ethanol was distilled off under initial stirring speed (150-200 min⁻¹). When 39 g of destillate was collected, heating was increased. The reaction mixture was heated to 150° C., where amide formation starts together with distillation of methanol and further kept between 170° C. and 185° C. where amidine condensation takes place. When a total of 74 g of distillate was collected, the reaction mixture was kept at 170° C. and 20 g of tetraethoxysilane [78-10-4] were added under stirring (150-200 min⁻¹). 226 g of clear reddish and slightly viscous product was obtained which increases viscosity significantly during cooling to room temperature. LOD@120° C./30 min of 82 wt-%. 20 g of product was mixed with a solution of 0.5 g of sodium hydroxide in 19.5 g of water in order to obtain a mixture which was suitable for coating by brushing. The mixture was divided into two parts. The first serves as Example 7 reference. The second part, was mixed with 5 g of product from example 1 and 5 g of product from example 5 in order to obtain Example 7 sample, which was a flame retardant comprising iron (III) dihydroxide benzoate and sucralose with a molar ratio of Fe and CI of about 1:3 in addition to nitrogen and silicon containing polymer. Iron (III) dihydroxide benzoate and Si—OH groups in the polymer can form Fe—O—Si bonds.

### EXAMPLE 8

Flame Retardant Mixtures Comprising a Molar Ratio of Fe and Cl of about 1:3

Flame retardant mixtures were prepared based on the iron comprising products in Example 1-4 and the chlorine comprising products in Example 5-6. The amounts of products in the different examples have been chosen in order to obtain a molar ratio of Fe and CI of about 1:3. However different mixing ratios were possible and may work as flame retardants. Table 1 below shows the flame retardant mixtures and their composition:

TABLE 1

| | Amount | | Amount | |
|---|---|---|---|---|
| Name | [g] | Component 1 | [g] | Component 2 |
| Example 8a | 5.0 | Example 4 | 10.4 | Example 5 |
| Example 8b | 5.0 | Example 1 | 4.9 | Example 5 |
| Example 8c | 5.0 | Example 2 | 17.0 | Example 5 |
| Example 8d | 5.0 | Example 1 | 5.9 | Example 6 |
| Example 8e | 5.0 | Example 3 | 3.7 | Example 5 |

### Burning Test of Cardboard

Packaging type cardboard (ca. 300 g/m²) was coated with the mixtures Example 8a-e and flame tested. The cardboard samples were about 8 cm in width and 20 cm in length. They were coated by brushing two times on the front side, which was exposed to the flame and one time on the backside. Drying was performed for 10 min in an air stream at 80° C.

Flame conditions:
butane lighter with about 20 mm flame
effect of 60-70 W calculated from butane consumption
vertical position of the sample in relation to the flame
top of flame in contact with cardboard sample for 60 seconds.

Table 2 shows the results of the flame test (burning test).

TABLE 2
Weight of burning test samples before and after burning test

| | | coated | coating | after | | |
|---|---|---|---|---|---|---|
| Name | raw [g] | [g] | [g] | fire [g] | loss [g] | loss [%] |
| reference | 3.78 | 3.78 | 0.00 | 0.18 | 3.60 | 95.2% |
| Example 8a | 3.68 | 4.12 | 0.44 | 3.73 | 0.39 | 9.5% |
| Example 8b | 3.71 | 4.35 | 0.64 | 4.17 | 0.18 | 4.1% |
| Example 8c | 3.62 | 3.88 | 0.26 | 3.71 | 0.17 | 4.4% |
| Example 8d | 3.74 | 3.97 | 0.23 | 3.74 | 0.23 | 5.8% |
| Example 8e | 3.64 | 5.10 | 1.46 | 4.82 | 0.28 | 5.5% |

A clear difference between the uncoated reference and the coated samples has been found. All coated samples were self extinguishing within 5 seconds after removal of the butane flame. Weight loss was thoroughly less than 10 wt-% for the coated samples and more than 95 wt-% for the uncoated reference. Most samples show a surprisingly low weight loss of 4-6 wt-%. These examples clearly demonstrate that mixtures of iron containing chemical substances and chlorine containing chemical substances can serve as highly efficient flame retardants on combustible substrates at low mass to mass ratios of flame retardant to substrate.

### EXAMPLE 9

Mixtures Comprising Alkyd Paint and Flame Retardant with a Molar Ratio of Fe and Cl of 1:3

Alkyd paint “Drygolin oljedekkbeis” (Jotun, Norway) was used for fire retardancy test on cardboard. The alkyd paint was solvent based and white pigmented with a content of volatile organic carbon (VOC)<400 g/I. For the reference sample the paint was used as received.

Two mixtures of paint and Example 8b have been prepared giving a ratio of flame retardant and paint in dry paint of 10 wt-% and 20 wt-% respectively. The burning test has been performed in a similar way as described in Example 8. Drying time was initially 4 hours at 60° C. and thereafter 80 hours at about 20° C. The 10 wt-% sample has been reproduced after storing the mixture of flame retardant and paint for 2 weeks and with about 50 wt-% of the coating thickness of the initial 10 wt-% sample. Table 3 below shows the results of the burning test:

TABLE 3
Weight of burning test samples before and after burning test

| | | coated | coating | | loss | loss |
|---|---|---|---|---|---|---|
| Name | raw [g] | [g] | [g] | name | [g] | [%] |
| reference | 3.76 | 5.06 | 1.30 | 3.95 | 1.11 | 21.9% |
| 20% Example 8b | 3.76 | 5.02 | 1.26 | 4.75 | 0.27 | 5.4% |
| 10% Example 8b | 3.83 | 5.57 | 1.74 | 5.29 | 0.28 | 5.0% |
| 10% Example 8b | 3.72 | 4.47 | 0.75 | 4.43 | 0.04 | 0.9% |
| (stored 2 weeks) | | | | | | |

A clear difference between the coated reference without flame retardant and the coated samples comprising flame retardant has been found. All flame retardant samples comprising flame retardant were self-extinguishing within 5 seconds after removal of the butane flame. Weight loss was around 5 wt-% or lower for the samples comprising flame retardant and more than 20 wt-% for the reference sample without flame retardant. The reference was not self-extinguishing within 5 seconds after removal of the butane flame. The amount of iron in the total sample 10 wt-% Example 8b (stored 2 weeks) is, as calculated from its preparation, 0.018 wt-% and the correspondent chlorine content was 0.034 wt-%. This shows that the disclosed flame retardants can provide flame retardancy at very low loadings.

### EXAMPLE 10

Burning Test of Cardboard with Coating Formulations from Example 7 Reference and Example 7 Sample.

The burning test has been performed in a similar way as described in Example 8. Drying has been performed for 10 min in an air stream at 80° C. Table 4 below shows the results of the burning test:

TABLE 4
Weight of burning test samples before and after burning test

| | | coated | coating | after | loss | |
|---|---|---|---|---|---|---|
| Name | raw [g] | [g] | [g] | fire [g] | [g] | loss [%] |
| uncoated | 3.78 | 3.78 | 0.00 | 0.18 | 3.60 | 95.2% |
| cardboard | | | | | | |
| Example 7 | 3.69 | 4.42 | 0.73 | 4.06 | 0.36 | 8.1% |
| reference | | | | | | |
| Example 7 | 3.66 | 4.41 | 0.75 | 4.23 | 0.18 | 4.1% |
| sample | | | | | | |

A clear difference between the uncoated reference and the coated samples has been found. Furthermore the fire retardancy of the neat polymer on the coated cardboard Example 7 reference was significantly improved by incorporation of flame retardant (Example 7 sample).

### EXAMPLE 11

Coating of Cardboard with Unsaturated Polyester and Burning Test

20 g of white pigmented unsaturated polyester gelcoat with a styrene content of 30-35 wt-% and 0.3 g of curing agent have been mixed and applied on cardboard similar to the procedure in Example 8 and 9. The obtained sample was the reference sample Example 11a. Example 11 b has been prepared by mixing 20 g of the same unsaturated polyester, 10 g of the product from Example 1 as iron containing component and 3.8 g 4-chloromethylene styrene as chlorine containing compound and 0.3 g of curing agent. Molar ratio of Fe and CI of about 1:3 for Example 11a. Example 11 b has been prepared by mixing 20 g of the unsaturated polyester, 10 g of the product from Example 1 as iron containing component and 7.5 g 4-chloromethylene styrene as chlorine containing compound and 0.3 g of curing agent. Molar ratio of Fe and CI of about 1:6 for Example 11b. Example 11a and Example 11b have been applied on cardboard in the same way as the reference. Curing time was initially 30 min at 60° C. and thereafter 6 hours at about 20° C. The burning test has been performed in a similar way as described in Example 8. Table 5 below shows the results of the burning test:

TABLE 5
Weight of burning test samples before and after burning test

| | | coated | coating | after | loss | |
|---|---|---|---|---|---|---|
| Name | raw [g] | [g] | [g] | fire [g] | [g] | loss [%] |
| reference | 3.66 | 4.33 | 0.67 | 0.96 | 3.37 | 77.8% |
| Example 11a | 3.72 | 4.67 | 0.95 | 3.44 | 1.23 | 26.3% |
| Example 11b | 3.69 | 4.33 | 0.64 | 4.13 | 0.20 | 4.6% |

A clear difference between the reference without flame retardant and the samples comprising flame retardant has been found. All samples comprising flame retardant were self extinguishing within 5 seconds after removal of the butane flame. whereas the reference sample burnt completely above the flame application zone.

### EXAMPLE 12

a) Flame retardant mixture forming char in addition to ferric chloride upon heating

2 g of flame retardant mixture 8a was heated by an infrared lamp (ca. 1 W/cm²) and the surface temperature of the flame retardant mixture was measured by an infrared thermometer. Initially the flame retardant mixture had a slightly brownish colour. At 130° C. the surface of the flame retardant mixture become dark and black, at 150° C. the flame retardant mixture had foamed and formed char throughout the heated material.

b) Heating of the chlorine containing substance of the flame retardant mixture in 12a) alone

2 g of sucralose solution as prepared in Example 5 were heated in the same way as the flame retardant mixture in Example 12a). The solution dried, no darkening or char formation was observed upon heating to 150° C. At 200° C. a slightly yellow to brownish colour occurred on top of the dried solution. Still no darkening and no char formation.

### EXAMPLE 13

### Flame Retardant Mixtures Comprising Ferric Chloride

In order to prove the flame retardant effect of ferric chloride two formulations 13a) and 13 b) comprising ferric chloride have been prepared and applied and tested as described in Example 8. The composition of the two formulations is given in Table 6.

TABLE 6
Composition of the two formulations 13 a) and 13 b)

| Example 13 a): | Example 13 b): |
|---|---|
| Mixture of | Mixture of |
| 10 g of anhydrous | 5 g of 13 a), |
| ferric chloride and | 5 g of a 50% aqueous solution of |
| 5 g of water | guanidinium chloride and |
| | 5 g of a 20% aqueous solution of |
| | polyvinylalcohol (fully hydrolyzed, M_{w} |
| | about 80000). |

The results after coating on cardboard and burning test are shown in Table 7 below.

TABLE 7
Weight of burning test samples before and after burning
test of Examples 13 a) and 13 b)

| | raw | coated | coating | after | loss | |
|---|---|---|---|---|---|---|
| Name | [g] | [g] | [g] | fire [g] | [g] | loss [%] |
| uncoated | 3.78 | 3.78 | 0.00 | 0.18 | 3.60 | 95.2% |
| cardboard | | | | | | |
| Example 13 a) | 3.93 | 5.24 | 1.31 | 5.06 | 0.18 | 3.4% |
| Example 13 b) | 3.75 | 4.63 | 0.88 | 4.34 | 0.29 | 6.3% |

The results show clearly that ferric chloride homogenously dispersed on the surface of a combustible material works as flame retardant. The uncoated sample burns almost completely under the same conditions. Therefor ferric chloride can be used as flame retardant. The corrosive properties of ferric chloride might impair its use in some applications. Passivation of ferric chloride by encapsulation or protective layers might hinder corrosion caused by flame retardants containing ferric chloride. No corrosive properties are expected with flame retardants according to the disclosure, when the ferric chloride is formed from non-corrosive precursors after exposure to flames.

Flame retardants according to the disclosure may be prepared independently from water-based formulations. Flame retardants may comprise one or more iron containing chemical substance and one or more chlorine containing chemical substance as solvent based formulation, as powder, as liquid and as mixture with one or more solid or liquid carriers.

Flame retardants according to the disclosure can provide flame retardancy at very low loadings such as 0.01 wt-% Fe and 0.01 wt-% Cl of the total weight of a flame retarded material or article. Higher loadings and molar ratios of Fe and Cl which were close to 1:3 such as 0.05 wt-% Fe and 0.1 wt-% Cl may provide improved flame retardancy. Even more improved flame retardancy may be obtained with even higher loadings such as 0.2 wt-% Fe and 0.4 wt-% Cl or with 1.0 wt-% Fe and 2.0 wt-% Cl. Industrial applicability, economical limitations and the chemical composition of ferric chloride, which was 34.4 wt-% Fe and 65.6 wt-% Cl limit the loadings of Fe and Cl in flame retarded substances and materials.

1-18. (canceled)

19. A method for the preparation of a flame retardant having iron and chlorine in the chemical compositions of its components, comprising the following steps:
(a) providing an iron containing chemical substance,
(b) providing a chlorine containing chemical substance, and
(c) mixing said iron containing chemical substance and said chlorine containing chemical substance, thereby obtaining a mixture that is reactable to form an at least partially volatile ferric chloride upon subsequent heating.

20. The method according to claim 19, wherein char is formed in addition to ferric chloride upon heating of the prepared flame retardant to at least 150° C.

21. The method according to claim 19, wherein the mixture is homogenous with average domain size of less than 500 nm.

22. The method according to claim 21, wherein the average domain size is less than 20 nm.

23. The method according to claim 19, wherein the iron containing chemical substance is selected from the group consisting of ferric hydroxide, ferric carboxylate, ferric salts of substituted carboxylates, ferric complexes of substituted carboxylates, ferric hydroxide carboxylate, ferric phosphate ester, ferric citrate, ferric gluconate, ferric silicate, ferric complexes with ligands comprising nitrogen and ferric substances comprising at least one covalent bond of the type Fe—O—Si, Fe—O—Al, Fe—O—Ti, Fe—O—C or Fe—O—P.

24. The method according to claim 19, wherein the mixture comprises carbon and hydrogen within the chemical composition of one or both of the iron containing chemical substance and the chlorine containing chemical substance, and wherein the atomic ratio of C:H in the mixture is greater than 0.50.

25. The method according to claim 24, wherein the atomic ratio of C:H in the mixture is greater than 1.0.

26. The method according to claim 19, wherein the chlorine containing chemical substance is a chlorinated sugar or a chlorinated waste product or an intermediate from sugar or sweetener production.

27. The method according to claim 19, wherein the chlorine containing chemical substance is a substance comprising nitrogen in its chemical composition, which is at least partially a hydrochloride or quaternary salt with a molar ratio of chloride to nitrogen with a range of 1:1000 to 1:1.

28. The method according to claim 27, wherein the substance comprising nitrogen in its chemical composition is selected from the group consisting of amines, amine oxides, amidines, guanidines, imines and aromatic heterocycles.

29. The method according to claim 19, wherein the chlorine containing substance comprises a covalent C—Cl bond with a dissociation energy that is lower than the dissociation energy of the covalent C—Cl bond in chloromethane and the type of carbon in the C—Cl bond is selected from the group of benzyl carbon, tertiary carbon, and allyl carbon.

30. The method according to claim 29, wherein the chlorine containing chemical substance is a polymer, oligomer or monomer.

31. The method according to claim 19, further comprising a step of mixing of the flame retardant with hydrophobic matter selected from a group comprising binders, thermoplastics, thermosets, waxes, oils, fats and solvents.

32. The method according to claim 19, wherein flame retardant is applied to substances or materials in order to obtain a content of at least 0.01 wt-% Fe and at least 0.01 wt-% Cl based on total weight of a flame retarded material.

33. The method according to claim 19, wherein the iron containing chemical substance and the chlorine containing chemical substance are identical.

34. The method according to claim 19, wherein all starting materials in the preparation of the flame retardant are selected from a group of food contact materials according to the amended Regulation (EU) No 10/2011.

35. A flame retardant or component in flame retardant mixtures prepared by the following steps:
(a) providing an iron containing chemical substance,
(b) providing a chlorine containing chemical substance, and
(c) mixing said iron containing chemical substance and said chlorine containing chemical substance, thereby obtaining a mixture that is reactable to form an at least partially volatile ferric chloride upon subsequent heating.

36. The flame retardant or component according to claim 35, wherein said flame retardant or component in flame retardant mixtures has the form of an aqueous or water dilutable solution or dispersion.

37. The flame retardant or component claim 35, wherein said flame retardant or component is present on a surface selected among a group consisting of paper surface, cardboard surface, wooden surface or within wooden plates, boards, laminates, and particle boards.

38. An article or product comprising at least one of binders, thermoplastics, thermosets, waxes, oils, fats, solvents, wooden plates, boards, laminates, and particle boards, comprising at least one flame retardant from claim 35.
